(19) United States
(12) Patent Application Publication
(10) Pub. No.: US 2006/0045011 A1
(43) Pub. Date: Mar. 2, 2006

(54) Methods and apparatus for use in packet-switched data communication networks

(76) Inventors: Abdol Hamid Aghvami, London (GB); Vasilis Athanasios Friderikos, London (GB)

Correspondence Address: PILLSBURY WINTHROP SHAW PITTMAN, LLP, P.O. BOX 10500, MCLEAN, VA, 22102, US

(21) Appl. No.: 10/536,380

(22) PCT Filed: Nov. 26, 2003
(86) PCT No.: PCT/GB03/05165

§ 371 Date: May 26, 2005

(30) Foreign Application Priority Data
Nov. 26, 2002 (GB) 0227499.1

(51) Int. Cl. H04L 12/26

(52) U.S. Cl. 370/230; 370/412

(57) ABSTRACT

A method of reducing packet congestion at a network node in a packet-switched data communication network, which method comprises the steps of marking one or more packets in said queue, wherein a probability of marking a packet in the queue is higher for a first proportion of the packets than for a second proportion of the packets, one or more packets of said first proportion having spent less time on said network than one or more packets of said second proportion.

### FIELD OF THE INVENTION

The present invention relates to a method of reducing packet congestion at a network node in a packet-switched data communication network, to a computer program product, to a network node for use in a packet-switched data communication network, to a packet-switched data communication network, to at a network node in a packet-switched data communication network a method of initiating a reduction in the transmission rate of packets from a first host transmitting data over that network, and to a method of reducing the aggregate power consumption of network nodes in an ad-hoc computer network.

### BACKGROUND OF THE INVENTION

The increasing popularity of the Internet as a means for transmitting data has resulted in rapid growth of the demand on its infrastructure. At present a large proportion of data is sent in “packet” form. A file or block of data that is to be transmitted from one computer to another (each usually termed a “host”) is broken down into packets (also know as datagrams) that are sent across the Internet. Each packet is wrapped with a header that specifies the source address and the destination address. These addresses are network addresses (layer 3 of the Open Systems Interconnect—OSI-model) that enable intermediate computers known as “routers” to receive and forward each packet to a subsequent router. Each router has a forwarding address table that is used to look up the network address of the next router based on the destination address of the packet. Each packet is independent of the others and packets from one host may traverse a different route across the Internet. At present the protocol widely used to send this packet data is the Internet Protocol (IP) that operates in the network layer. However, this protocol provides neither guarantee of delivery of each packet nor any feedback to the sender of the condition of the network.

Monitoring of transmission of data in packet form is frequently performed at the transport layer (layer 4 OSI). A protocol most frequently used with IP is the Transmission Control Protocol (TCP). TCP wraps a portion of data in its own header that the sender and receiver use to communicate with on another to ensure data is transmitted reliably. This portion of data plus header is known as a “TCP segment”. During transmission, each TCP segment is passed down to the network layer to be wrapped in an IP header as described above.

One particular problem is that packets sent across the network may not reach their intended destination. This can happen for a variety of reasons one of the most common being congestion on the network. The routers that perform the forwarding task can only process and forward a limited number of packets per second. When the arrival rate of packets exceeds the forwarding rate, the router buffers arriving packets in a queue in memory, and congestion results where the time each packet spends on the network is not simply the sum of the transmission time (i.e. time to place data on the physical medium), the travelling time between routers and processing time at each router. When queued, packets are often processed in a First-In-First-Out regime. However, once the buffer is full, any further packets that arrive are simply dropped. This is known as the “drop-tail” queuing method. Consequently, although buffers can accommodate a certain amount of data during a high rate or burst-like data flow period, there comes a point where packets must be dropped.

TCP attempts to control and avoid congestion on the premise that the Internet (or a network) is a “black box”. End systems (sender and receiver) gradually increase load on the black box (in TCP's case by increasing the sender's congestion window i.e. number of packets per second or transmission rate) until the network becomes congested and a packet is lost. The end system then concludes that there is congestion and takes action (in TCP's case the receiver reduces its congestion window causing the sender to reduce transmission rate). This is known as the “best-effort” forwarding service over IP.

One particular problem with this method is that packets are dropped randomly and this can have adverse consequences on network capacity. A packet that is dropped must be re-transmitted, and in some circumstances all packets received subsequent to the loss but before it is noticed by the receiver must be re-transmitted. Re-transmission of packets having higher residence time on the network between sender and receiver results in greater consumption of network capacity than re-transmission of packets that have spent comparatively less time resident on the network. Such packets having a comparatively long residence time are also more likely to need to cross the Internet backbone where, due to huge traffic volume, router resources are scarce. This can result in degradation of the quality of service, for example in terms of delay, for some or all users on the network. Such a problem often manifests itself in slow downloading of web pages for example, and more generally reduced average data transfer rates.

The delay experienced by packets crossing the Internet increases exponentially with the number of routers that the packet crosses and linearly due to propagation time between routers (assuming that there is a uniform distribution of link capacities). One measure of this delay is the Round Trip Time (RTT) of a packet from sender to receiver i.e. the time taken for the packet to reach the receiver plus the time for the receiver's acknowledgement to reach the sender. RTTs of between 3 ms and 600 ms are frequently encountered on the Internet today. If throughput (i.e. performance) is analysed in terms of the mean size of the congestion window that a sender utilises during a TCP session it is observed that the mean congestion window is heavily dependent on RTT. This is because RTT is effectively a measure of how frequently a sender can increase or decrease its congestion window. Accordingly a sender with a large RTT will be slow to increase its congestion window from the outset. When a packet is lost it will take longer to return to the previous value of the congestion window than a sender with a lower RTT.

A further problem that, to the best of the applicant's knowledge, has not been considered in detail is the data traffic patterns of mobile users having wireless devices. Such patterns will be almost certainly be different to that of desktop users, and are likely to be of short duration but requiring high bandwidth. It is believed that since such users will be at the “edge” of the Internet, they will be more likely to suffer from larger RTTs and their quality of service will be more sensitive to a packet loss event than those hosts with lower RTTs. Furthermore, the networks that such users will rely upon may well be ad-hoc in nature, and re-transmission of lost packets between these hosts will place larger demands on network resources.

One particular resource of paramount concern in ad-hoc networks is battery life because ad hoc nodes are by definition mobile nodes with limited capabilities. Clearly it is desirable to preserve battery power if at all possible. In ad-hoc networks a group of devices (mobile telephones, PDAs, notebook computers, sensors, etc.) may establish a network to support communication between them. With no fixed routers providing the communication infrastructure, at least some of the devices must perform a routing to support communication between devices that are outside direct communication range with one another. Performing the routing function drains the battery as power is needed to receive, process and transmit each packet of data. Despite their usually small size (less than about 200 devices) ad-hoc networks can also suffer from congestion at the network layer. This can be exacerbated by reliability difficulties with data transmission over the wireless link at the MAC and physical layers, which often results in more frequent re-transmission of packets than on a wired network. Where packets have to be re-transmitted this results in additional consumption of energy at each wireless device through which the packet must be routed to its destination. Packets that have crossed a large number of ‘routers’ in the ad-hoc network (or that have a high roundtrip time) that have to be re-transmitted consume more energy in the routing devices than those flows with a comparatively short roundtrip time.

Several Active Queue Management (AQM) techniques have been proposed to reduce congestion difficulties experienced at routers in the Internet and to provide fair allocation of bandwidth to a user's flow. Most of these have concentrated on providing some monitoring of each flow to inhibit a small proportion of users taking the largest share of the available bandwidth. However, such methods are difficult to implement on a large scale and are demanding on CPU resources since each flow must be monitored individually. Furthermore, such methods will be even more difficult to implement for mobile users who have very small flows of short duration.

AQM necessarily involves dropping packets from the queue in the router since it is not possible to increase the router's buffer size beyond limit. Since at present 90-95% of traffic on the Internet is between hosts implementing TCP, transmission rates are controlled by dropping packets. Dropping packets frees the space in the router's memory and serves to control transmission rates so that the network does not become overloaded.

However, at present, none of the AQM techniques have solved the problem of reducing congestion at routers, whilst at the same time protecting those TCP sessions that are more sensitive to packet loss than the majority of the traffic in the router.

One of the more important AQM techniques is Random Early Detection (RED). RED detects congestion before a router's buffer is full (thereby avoiding a drop-tail scenario) and provides feedback to the sender by dropping packets. In this way RED aims to keep queue sizes small, reduce the burst-like nature of senders and inhibit the chances of transmission synchronisation between senders in the network.

RED maintains a record of the average queue length calculated using an exponential weighted average of the instantaneous queue length (measured either in number of packets or bytes). Minimum and maximum queue length thresholds are set based on the traffic pattern through the router and the desired average queue size. When the average queue length is below the minimum threshold no packets are marked. When the average queue length is between the minimum and maximum thresholds packets have a probability of being marked that is a linear function of the average queue size, ranging from zero when the average queue size is near the minimum threshold to a maximum probability when the average queue size is near the maximum queue length threshold. Incoming packets are marked randomly. When the average queue length is above the maximum threshold all packets are dropped. Marking of packets may be by dropping a packet, setting a bit in the IP header or taking any other step recognised by the transport protocol.

One problem with this method is that the feedback concerning congestion at the router is provided to random senders i.e. senders are picked at random and indirectly instructed to reduce their congestion window. Thus flows with large RTT are treated equally to flows with low RTT. No consideration is given to reducing the transmission rates of hosts that will be least affected, and/or that can recover their transmission rate more quickly.

EP-A-0 415 843 discloses a congestion avoidance method in which each sending node measures round-trip times (RTTs) for packets that it has sent over the network. The RTTs are measured for different load levels (e.g. window size, packet transmission rate), and then the actual window size or transmission rate is chosen on the ratio of (1) the relative difference between the two RTTs and (2) the relative difference between the loading of the network at the two RTTs. This method is an “end-to-end” method e.g. between Internet hosts, and is not within the routing infrastructure.

Hamann, T. et al., “A New Fair Window Algorithm for ECN capable TCP”, Infocom 2000, Nineteenth Annual Joint Conference of the IEEE Computer and Communications Societies, Proceedings IEEE Tel Aviv, Israel 26-30 Mar. 2000, pages 1528-1536 (XP010376090, ISBN: 0-7803-5880-5) mentions the problem that flows with large RTT face on the Internet. The solution to this problem is a new window control algorithm (i.e. at the sending host) that is activated when congestion is detected by RED and notified to the sender using Explicit Congestion Notification. This document suggests a combined solution of sender window control and active queue management using RED to control congestion. This method relies on action taken by sending hosts in response to message sent from the routing infrastructure. The additional signalling overhead is undesirable and the method not simple enough for widespread implementation throughout the Internet.

Accordingly it is apparent that there is a need for an improved active queue management method that addresses at least some of the aforementioned disadvantages and more particularly, but not exclusively, reduces the effect on hosts that are more sensitive to packet loss i.e. those with larger than average RTT, and that can reduce aggregate battery power consumption in ad-hoc networks where a fixed routing infrastructure is not present. Aggregate power consumption means the power consumption of all of the network nodes that perform a routing function.

### SUMMARY OF THE PRESENT INVENTION

Preferred embodiments of the present invention are based on the insight that it is possible to maintain or enhance the performance (i.e. quality of service) of hosts with connections passing through a network node that span a comparatively large number of other network nodes using information representative of the residence time of packets of each connection travelling across the network. The residence time of packets on the network can be indicated for example by the RTT, one way trip time or number of network nodes (or “hops”) that a packet has crossed to the present point in its journey.

Some embodiments implement the method in response to an indication of congestion at the network node. On indication of congestion, as determined by RED or a drop-tail method for example, packets in the queue of the network node have a probability of being marked by the network node that is dependent upon the residence time of each packet on the network: packets that have a longer residence time on the network have a probability of being marked less than packets that have spent less time on the network. In the context of packets sent under an IP protocol this information is available to the network node in the Time To Live (TTL) field in an IPv4 header, or in the Hop Limit (HL) field in an IPv6 header. This information must be extracted by the network node in any event as the field must be decremented by one at each network node, so that implementation of the method will not consume a prohibitive amount of CPU resources.

According to the present invention there is provided a method of reducing packet congestion at a network node in a packet-switched data communication network, which method comprises the steps of marking one or more packets in a queue, wherein a probability of marking a packet in the queue is higher for a first proportion of the packets than for a second proportion of the packets, one or more packets of said first proportion having spent less time on said network than one or more packets of said second proportion. In this way, flows that have a longer residence time on the network are protected relative to those that have spent less time on the network. Accordingly, capacity of the network is saved since flows with higher RTT are less likely to be re-transmitted, reducing capacity required at the backbone (in other words increasing the “goodput” at the backbone). The effect is particularly beneficial at the “edge” of the Internet. No monitoring of individual flows is required and is therefore efficient in terms of CPU time utilisation. In one embodiment the method is implemented in the network layer (layer 3 OSI). Alternatively the method may be used in a layer 2 device, for example a base station operating under Universal Mobile Telecommunication Service (UMTS). The time spent on the network may be that spent on part of the network, rather than the complete round trip or one-way trip time.

Two of the strengths of a method according to the present invention are its simplicity and its utilisation of information already existing in the network. This permits easy implementation at a large number of routers or network nodes without placing undue overheads on network resources. To the best of the applicant's knowledge and belief this information has not been exploited before. Other proposed methods require complicated algorithms to implement, special measurement of one or more parameters and are therefore resource intensive. Where network nodes have limited resources, such as the limited battery power of wireless communication devices, the method can offer overall energy saving advantages when if ad-hoc network is established between the devices.

It is expected that the method will be especially useful in gateway network nodes, for example the node between an IPv6 and an IPv4 network, or between two autonomous systems. This is because the gateway network node has a “complete” view of either network, in terms of residence time, of arriving packets.

Preferably, the method is initiated in response to an indication of congestion at said network node caused by a queue of packets awaiting processing at said network node. The indication may be provided by an active queue management technique, for example Random Early Detection (RED). Thus, detection of congestion may be determined by comparing the average queue length in packets or bytes for example, against a maximum and minimum threshold. However, an indication of congestion may be generated by any method.

The method may also be performed to provide fairness between TCP flows at a network node and in this case it may not be necessary to initiate the method in response to an indication of congestion. For example, the method may be run substantially continuously on a Differentiated Services capable network node that may wish to provide different qualities of service to different classes of TCP flow. The method can be used to ensure fairness within each class by protecting flows with a large packet residence time on the network relative to those with a lower packet residence time in that class. In this case, incoming packets are marked, as there will be no queue from which to pick packets for marking.

Due to the global dimension of the Internet the probability distribution function of the number of hops that packets cross before reaching their destination takes the form of a “long tail” lognormal distribution, with most packets reaching their destination with a low number of hops (e.g. less than 15). It will be at least one RTT before the network node detects any reduction in the arrival rate of packets. Therefore, this method helps to increase the reaction time of the network to congestion since flows with smaller RTTs will reduce their transmission rates sooner, and the congestion will be dealt with faster.

Advantageously, said time spent on the network is indicated by the number of network nodes crossed by each packet, the method further comprising the step of determining said probability using said number of network nodes. In one embodiment each packet comprises an Internet Protocol (IP) header, the method further comprising the step of obtaining the number of network nodes by reading the Time To Live (TTL) field in an IPv4 header, or from the Hop Limit field (HL) in an IPv6 header of each packet. Since each network node must do this in any event, determining the probability of marking based on this value is beneficial as no additional CPU resources are need to perform any special measurement. Alternatively, the probability may be determined using the round trip time, or one-way trip time from sender to receiver, or any other parameter representative of residence time. For example, round trip time may be estimated by passive measurements of traffic flow at the network node.

Preferably, the method further comprises the steps of examining the queue to determine a maximum number of network nodes and a minimum number of network nodes crossed by packets therein, and determining a probability of being marked for each network node number between said maximum and said minimum. The probability may be the same for a first group of network node numbers and different for a second group of network node numbers. Alternatively the probability may be different for each network node number.

Advantageously, said probability varies as a function of the time each packet has spent crossing the network or as a function of or number of network nodes. In one embodiment, said function is of substantially linear form and the probability is inversely proportional to the time each packet has spent resident on the network or the number of network nodes crossed by each packet. Such a method is particularly advantageous for routers located near the “edge” of the Internet, or those that participate in ad-hoc networks where protection of flows with large RTTs is of vital importance.

Preferably, said probability is determined in accordance with the “exact” method described herein.

Advantageously, packets in said first proportion have a substantially constant first probability of being marked and packets in said second proportion have a substantially constant second probability of being marked lower than said first probability. When shown graphically, such a probability function is a step function. Such a method is particularly useful for routers that must process a very large number of packets per unit time, for example routers in the backbone of the Internet. It is also particularly useful in wireless ad-hoc networks where its use helps to reduce energy consumed by the network during the routing process, thereby preserving battery life of at least some of the nodes that perform a routing function.

Preferably, the packets in the queue are divided into said first and second proportions by a threshold based upon the mean number of networks nodes crossed by the packets in the queue. In one embodiment, the threshold is approximately equal to the mean number of hops in the queue plus one standard deviation. In this way flows in the “long-tail” part of the probability distribution of hop number are protected relative to the remainder.

Advantageously, said probability is determined in accordance with the “coarse” method described herein.

Advantageously, the step of marking a packet comprises dropping the packet, setting the Explicit Congestion Notification bit in the IP header or performing any other step that identifies congestion to the transport protocol used by the intended recipient of the packet. In this way, the transport protocol, for example TCP, is manipulated to reduce the transmission rates of those users that can recover their previous transmission rates more quickly relative to those users whose packets have a longer residence time on the network.

Preferably, the method further comprises the step of repeating the method upon receipt of a further indication of congestion at the network node. Thus continuous monitoring is provided.

According to another aspect of the present invention there is provided a computer program product storing computer executable instructions in accordance the method above. The instructions may be embodied on a record medium, in a computer memory, in a read-only memory, or on an electrical carrier signal, for example. In one aspect such instructions may be electronically stored at a network node that is part of a fixed infrastructure. When required the instructions may be downloaded (e.g. over a wireless link) to another network node, for example a wireless node, that may wish to participate in an ad-hoc network. In this way other network nodes, not part of the fixed infrastructure, can be enabled with the method.

According to another aspect of the present invention there is provided a network node for use in a packet-switched data communication network, which network node comprises means for receiving packets from other network nodes, means for determining the identity of a subsequent network node to which each packet should be sent, means for temporary storage of packets and means for forwarding each packet to the subsequent network node, further comprising a memory storing computer executable instructions in accordance with a method herein, and processing means for executing said instructions. Advantageously, the network node is embodied in an OSI layer 4 routing device, for example a router and a gateway router, any other layer 3 routing device or a hand-held wireless device. The instructions may be implemented on indication of congestion. They may be performed to provide the required quality of service to flows passing through the router for example. The network node might be any wireless communication device, e.g. a notebook computer, a wireless sensor device, a mobile telephone, a personal digital assistant (PDA), wireless headphones.

According to another aspect of the present invention there is provided a packet-switched data communication network comprising a plurality of network nodes, each of which can send and receive packets of data to and from other network nodes, wherein one or more network nodes is in accordance that described above. The packet-switched data communication network may be a telecommunication network, the Internet, or a smaller network such as an ad-hoc network or intranet employed by a university for example.

According to another aspect of the present invention there is provided at a network node in a packet-switched data communication network, a method of initiating a reduction in the transmission rate of packets from a first host transmitting data over that network, which method comprises the steps of:

(1) receiving a packet directly or indirectly from said first host destined for a second host reachable directly or indirectly from said network node; and

(2) either marking or not marking said packet, a probability of marking the packet being determined on the basis of the time said packet has spent on at least a part of said network;

wherein marking of said packet serves to cause a subsequent reduction of said transmission rate from said first host. Any of the above steps may be combined with this method to further control one or more user's transmission rate. Furthermore, there is provided a computer program product comprising computer executable instructions in accordance with such a method, a network node, and a packet-switched data communication network.

According to another aspect of the present invention there is provided a method of reducing the aggregate battery power consumption by network nodes in an ad-hoc computer network, which method comprises the steps of:

(1) using at least one of the network nodes to route data between communicating network nodes of the ad-hoc computer network; and

(2) at one or more routing network node using a method in accordance with the method above to mark packets passing therethrough, whereby packets in flows of data with a roundtrip time that is high compared to other flows of data through that routing network node have a lower probability of re-transmission across the ad-hoc network, thereby reducing the aggregate battery power consumption of routing network nodes in the ad-hoc computer network. Furthermore, there is provided a computer program product comprising computer executable instructions in accordance with such a method, a network node, and a packet-switched data communication network.

### BRIEF DESCRIPTION OF THE FIGURES

In order to provide a more detailed explanation of how the invention may be carried out in practice, preferred embodiments relating to use on the Internet will now be described, by way of example only, with reference to the accompanying drawings, in which:

FIG. 1 is a schematic view of the Internet, showing a selected number of routers and hosts;

FIG. 2 is a schematic representation of an IPv4 header;

FIG. 3. is a schematic representation of an IPv6 header;

FIG. 4 is a schematic graph of number of hops (x-axis) against delay in seconds (y-axis) illustrating two kinds of delay for packets crossing the Internet in FIG. 1;

FIG. 5 is the results of a DOS TRACERT command showing the time taken for a packet to travel from one host to another across the Internet, together with identities of the routers crossed by the packet;

FIG. 6 is a schematic representation of a router used in the Internet of FIG. 1;

FIG. 7 is flowchart showing the overall operation of a method in accordance with the present invention;

FIG. 8 is a schematic view of a network used to test a method in accordance with the present invention;

FIG. 9 is a flowchart showing a first embodiment of a method in accordance with the present invention;

FIG. 10 is a graph of number of hops (x-axis) against Round Trip Time (RTT) (y-axis);

FIG. 11 is a graph of number of hops (x-axis) against probability (y-axis) illustrating how a marking probability may be determined in the first embodiment for packets having traversed i hops;

FIG. 12 is a flowchart showing a second embodiment of a method in accordance with the present invention;

FIG. 13 is a schematic graph of number of hops (x-axis) against relative frequency (left hand y-axis) and delay (right hand axis);

FIG. 14 is a three-dimensional graph of the threshold θ in number of hops (y-axis) against marking probability (x-axis) and mean excess delay in seconds (z-axis) on which a method in accordance with the present invention is compared with a drop tail method;

FIG. 15 shows two graphs of time (x-axis) against sequence number (y-axis) for the network of FIG. 8, the upper graph showing application of a method in accordance with the present invention and the lower graph showing a drop tail method;

FIG. 16 shows two graphs of time (x-axis) against throughput (y-axis) in kB/s or a user receiving data through the gateway in FIG. 8, the upper graph showing results with the gateway employing a method in accordance with the present invention and the lower graph showing results with the gateway employing a drop tail method;

FIG. 17 is a schematic graph of time (x-axis) against congestion window (y-axis) for two hosts with different round trip times;

FIG. 18 is a three-dimensional graph of the threshold θ in number of hops (y-axis) against marking probability (x-axis) and energy consumption in Watts (z-axis) on which a method in accordance with the present invention is compared with a drop tail method; and

FIG. 19 is a bar chart comparing a method according to the present invention with a prior art method.

### DETAILED DESCRIPTION OF THE PREFERRED EMBODIMENTS

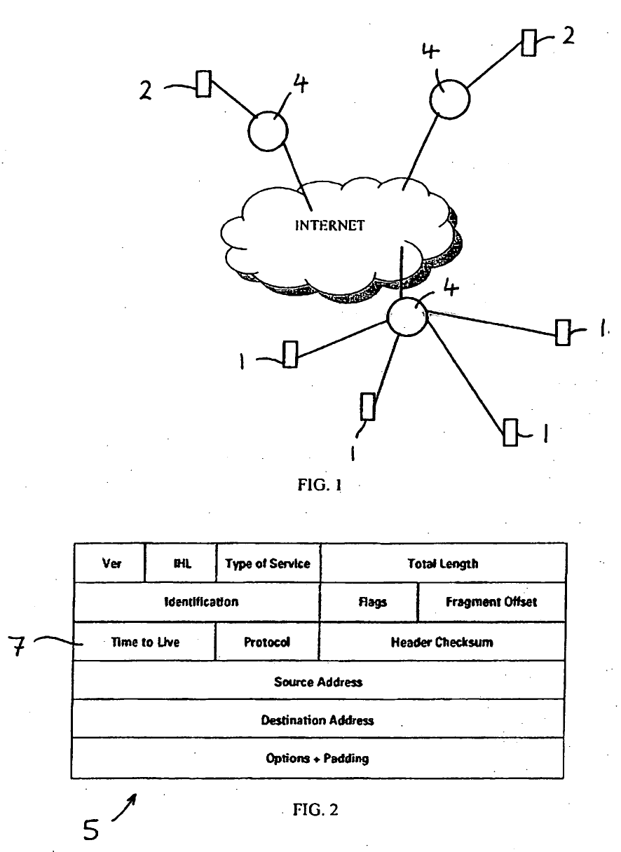

Referring to FIG. 1 a number of users 1 download data from and/or send data to hosts 2 across the Internet 3. As is well known, the Internet 3 is global “network of computer networks” that enables computers to communicate with one another. The users 1 may be personal computers, notebooks or wireless devices. The hosts 2 are usually dedicated servers, but may be other personal computers, notebooks or wireless devices. One of the users 1 may request one of the hosts 2 to send a computer file over the Internet 3. The host 2 sends the file over the Internet 3 via a plurality of routers 4.

Although not universal, most data transfer over the Internet (and other computer networks) is performed by breaking a file into packets and transmitting the packets individually. Much of this transfer is performed using TCP/IP (Transmission Control Protocol/Internet Protocol) protocols. Although there are many packet transmission protocols, TCP/IP is probably the most widely used today. In terms of the OSI (Open System Interconnection) reference model, TCP is a layer 4 (transport) protocol and IP is a layer 3 (network) protocol. TCP is a virtual circuit protocol that is connection oriented in nature. However, the connection orientation is logical rather than physical. IP operates in a connectionless datagram mode and establishes the nature and length of the packets, and adds various addressing information used by the various switches and routers of the Internet to direct each packet to its destination.

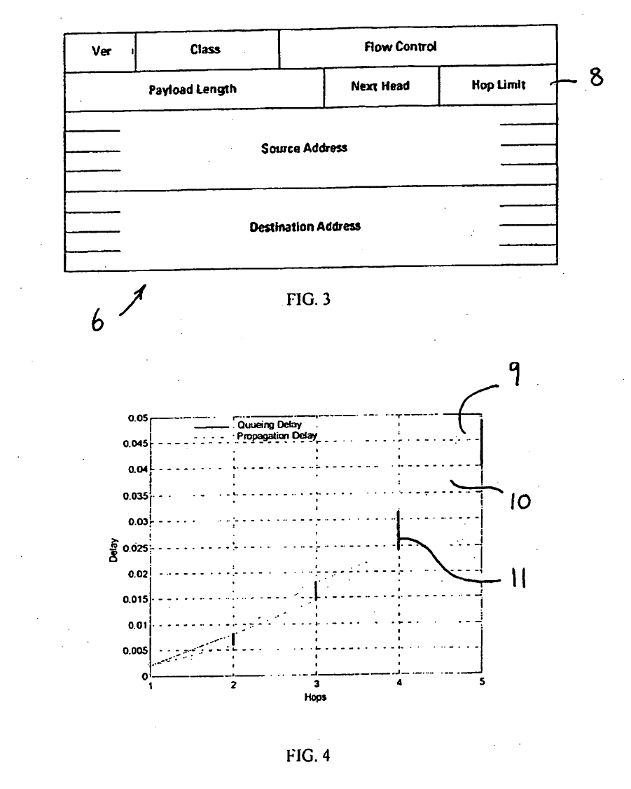

As the host 2 prepares to send the requested file, the data stream representing the file is fragmented by the host 2 into segments. Each segment is appended to a header that contains source and destination addresses, a sequence number and an error control mechanism to form a TCP segment. The TCP segments are then passed down to the IP layer where the segments are encapsulated in an IP header to form a packet. FIGS. 2 and 3 show an IPv4 (IP version 4) header 5 (20 bytes) and an IPv6 (IP version 6) header 6 (40 bytes) respectively. IPv6 is intended to replace IPv4 over time (probably over the next 10 to 15 years).

The fields of interest for the purposes of the present invention are the “Time to Live” field 7 in the IPv4 header 5 and the “Hop Limit” (HL) field 8 in the IPv6 header 6. The “Time to Live” (TTL) field specifies the time in seconds or, more commonly, the number of hops a packet can survive. A hop is counted as the packet passes through one router. At each router or network node the “Time to Live” field 7 is decremented by one until is reaches zero when the packet is discarded if it has not reached its destination. Similarly the “Hop Limit” field 8 is decremented by one at each router until it reaches zero when the packet is discarded.

Once an IP header has been added to a TCP segment, the packet is passed to the Data Link Layer (Layer 2 OSI) where Media Access Control is applied together with Logical Link Control to place the data on to the physical layer (cables, wireless, etc.) in an orderly manner.

Packets pass from the host 2 through various routers 4 until they reach their destination i.e. user 1. It is not necessary for each packet or datagram to travel the same physical route since the TCP protocol of the user's computer checks integrity of the data of the file as it is received. If any data is missing the user's computer sends a duplicate acknowledgement to the host computer that initiates retransmission of the missing packet (or packets).

When each packet arrives at a router 4 its destination address (shown in the IP header) is checked and the packet forwarded onto the next appropriate router 4 determined by a routing table in the router. The routing table contains details of a large number of destination addresses and the appropriate next router for a given destination address. At each router the TTL field 7 or HL field 8 is decremented by one.

Due to the large number of users sending and receiving data over the Internet 3, it is not always possible for each router 4 to deal with a packet as soon as it arrives. Accordingly, if the rate at which packets are received exceeds the rate at which they are forwarded, packets are placed in a “queue” that is operated on a FIFO (first-in-first-out) basis. Packets are stored in a buffer until they are ready to be processed and forwarded. If the buffer becomes full all packets subsequently received are dropped until such time as there is space in the buffer. This is known as “drop-tail” queuing.

The inherent delay facing packets traversing the Internet 3 is (1) transmission and propagation delay i.e. the time for the signal to be placed on the physical network and the time for it to traverse the physical distance between one router and the next, and (2) processing delay caused by the time taken for each router to process a packet and forward it on to the next router. Processing delay includes any queuing delay. FIG. 4 shows schematically both types of delay as a function of the number of hops i.e. network nodes crossed by a packet. The overall delay 9 comprises the propagation delay 10 and the processing delay 11, and is non-linear. As is clearly seen, propagation delay 10 is a linear function of the capacity (i.e. bandwidth) of the link between one router and the next. At each router the processing delay is a delta function imposed on the propagation delay. The magnitude of the delta function depends primarily on the queue at the router, but also on the processing time taken by the router. In general, processing delay increases at each router, although for a specific packet the processing delay may increase or decrease from one router to the next. The non-linear function of the overall delay 9 may be caused by the variety of packet sizes in the network, different routing paths and particularly the burst-like nature of IP traffic. This burst-like nature is caused by the flow control and error control mechanisms of TCP. The host 2 expects that for each packet sent it will receive an acknowledgement of safe receipt of that packet from the user 1 within a time limit. Together with that acknowledgement, the user 1 advertises a “congestion window” (cwnd) to the host 2. In the initial stages of communication the user 1 increases its cwnd exponentially (known as the “slow start” phase). However, if the user 1 fails to receive a packet, it cuts it cwnd in half (under TCP Reno), inferring that there is congestion on the Internet i.e. some routers on the path have full or nearly full queues. This may be indicated by a TCP timeout or if the receiver sends a duplicate acknowledgement when a packet is missing. When packets are successfully received again the cwnd is increased linearly until another packet is lost. Since packet loss is frequent, data transmission under TCP is often burst-like in nature due to the sender's control of cwnd.

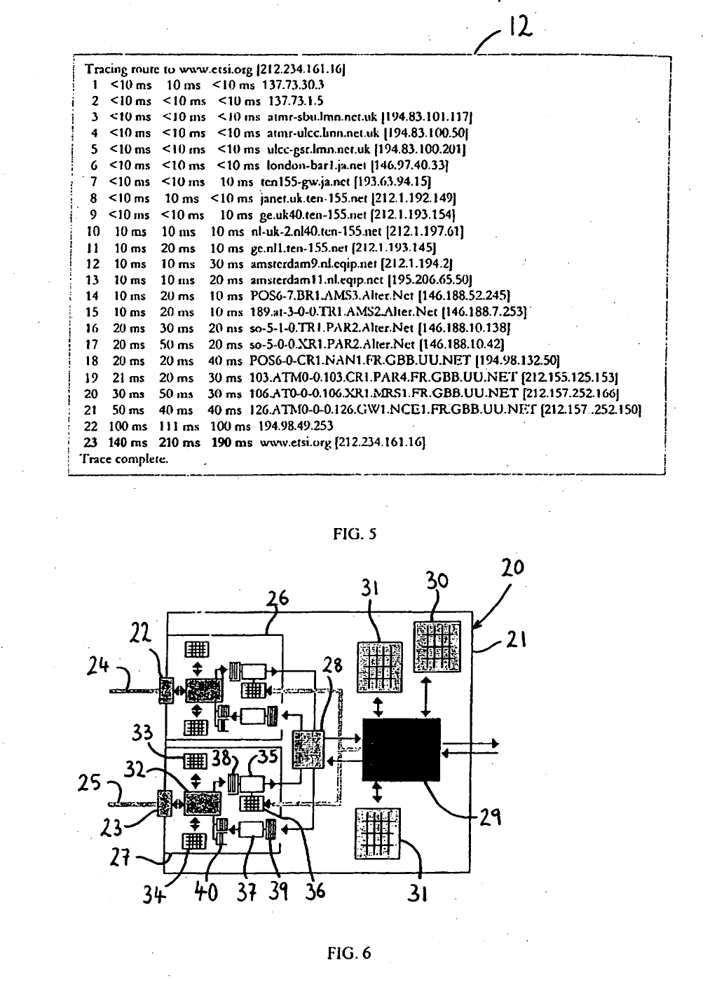

Referring to FIG. 5 a further illustration of the two types of delay in the form of a “trace route” 12 was generated using the DOS TRACERT command. This command traces the route of a packet from the source computer to the destination host. The identity of each router over which the packet passes is shown together with the time taken for the packet to reach each router, together with the overall round trip time shown in bold type. The trace route 12 shows the path of a packet from a host in King's College London to the web site of the European Telecommunications Standards Institute (www.etsi.org) in Sophia Antipolis. It will be seen that the time taken to traverse the Internet was approximately 140 ms. Assuming that the signal propagation speed of 2×10⁸ ms⁻¹ (⅔ speed of light) and that the distance between London and Sophia Antipolis is approximately 2800 km, the time for the signal to reach its destination is approximately 14 ms. Accordingly it is clear that traversing 23 routers has increased the round trip time by a factor of ten.

FIG. 6 shows a router generally identified by reference numeral 20 that comprises a case 21 having network interface ports 22 and 23 to which respective cables 24 and 25 provide a physical link to respective IP networks. The router 20 may be one of the routers 4 in FIG. 1. Two network interface cards 26 and 27 are connected to their respective network interface ports 22 and 23. A hardware packet switch 28 connects the network interface cards 26 and a central processing unit (CPU) 29 can communicate with a routing table 30 and router management tables 31.

Each network interface card 26, 27 comprises a link layer protocol controller 32 that has access to an interface management table 33 and a hardware address table 34 (e.g. Address Resolution Protocol cache). In communication with the link protocol controller 32 is a network protocol forwarding engine 35 having access to a forwarding table 36 (route cache), and an interface queue manager 37. Both the network protocol forwarding engine 35 and interface queue manager 37 have an interface to and from the packet switch 28 respectively.

In use, frames are received by the link layer protocol controller 32 that handles the link layer protocol (e.g. HDLC, Ethernet) used over the physical link. Frame integrity is checked and valid frames are converted into packets by removing the link layer header and, if necessary, the packets are queued in a queue 38. Storage capacity is often in the form of a ring of memory buffers. One packet at a time is removed from the queue 38 by the network protocol forwarding engine 35 and the forwarding table 36 determines whether or not the packet requires detailed examination by the CPU 29. Via the CPU 29 the next router to which the packet should be sent is looked up in the routing table 30. Once the destination IP address is found the CPU searches the ARP cache for a Media Access Control (MAC) address for the destination. The TTL field or HL field of the packet header is reduced by one. The CPU 29 now knows where to send the packet and the new link layer header to use. The link layer address is added and the packet is linked into the list of frames to be sent on from the appropriate network interface card. The packet is then forwarded to the packet switch 28 and onto the network interface card where the packet joins a queue 39 to be processed by the interface queue manager 37. From here the packet joins one of a number of link output queues 40 until the link layer protocol controller 32 can process it. The link layer protocol controller 32 encapsulates the packet in a link layer header that includes the Media Access Control (MAC) address of the next router to which the packet is to be sent. The MAC address is obtained from the hardware address table 34. The packet is then placed on the physical channel by the link layer protocol controller 32.

The queues primarily of interest for the present invention are the queues 38 in each network interface card ahead of the network protocol forwarding engines 35. This is where incoming packets wait to be forwarded under control of the CPU 29. However, the present invention could be applied to the queues 39.

Various types of router are available and the present invention is not limited to that described above. Further examples are available from Cisco Systems, Inc. (www.cisco.com) for example.

The router 20 may also be embodied in a personal computing device, for example a notebook computer or a hand-held device such as a personal digital assistant or mobile telephone. In this way the invention used for routing packets in ad-hoc networks, such as wireless ad-hoc networks. The personal computer may not have exactly the same hardware or software as the router 20, but will have: means for receiving packets from other network nodes e.g. a wireless network interface card with an antenna; means for determining the identity of a subsequent network node to which each packet should be sent e.g. a routing table stored electronically in memory with IP addresses of some or all of the other devices in the ad-hoc network; means for temporary storage of packets e.g. electronic memory such as RAM; means for forwarding each packet to the subsequent network node e.g. a wireless network interface card that may be the same as mentioned above; an electronic memory e.g. hard-disk or RAM for storing computer executable instructions in accordance with the method; and processing means e.g. a CPU for executing the instructions when necessary.

Referring to FIG. 7 a flowchart of the overall operation of a method in accordance with the present invention is generally identified by reference numeral 50. The method may be brought into operation when there is an indication of congestion at a particular router. Presently under transmission using TCP/IP a dropped packet indicates congestion. This congestion may be indicated by a variety of queue management techniques. The simplest technique may be a drop-tail i.e. when the buffer of the router is full incoming packets are simply dropped. The method of flowchart 50 may be implemented when the buffer is full or more than 50% or 75% full for example. Alternatively the router may employ an active queue management technique. For example, Random Early Detection (RED) has been widely researched and is now being employed to a very limited extent on the Internet. The RED algorithm “marks” packets in a congestion scenario. This marking may be by dropping the packet, or setting the Explicit Congestion Notification bit in the IP header for example, or any other method understood by the transport protocol being used. As mentioned above, RED calculates a mean queue size (in number of packets or bytes) using an exponential weighted average of the instantaneous queue length. Minimum and maximum thresholds are set for the mean queue size. The RED algorithm operates as follows: when the mean queue size is less the minimum threshold, no packets are marked. When the mean queue size is above the maximum threshold, all packets are marked. When the queue size is between the minimum and maximum thresholds packets are marked with a probability that is a linear function of mean queue size. Further details of the RED algorithm can be found in “Random Early Detection Gateways for Congestion Avoidance”, Floyd & Van Jacobson, 1993 IEEE/ACM Transactions on Networking which is fully incorporated herein by reference.

Some embodiments of the present invention utilise the congestion indicator provided by RED (or any other notifier of congestion), but implements a completely different method of determining which packets should be marked.

At step S1 a packet is received by the router (e.g. the router described above) and at step S2 the RED algorithm (or that implemented by the router) determines whether or not there is congestion according to the mean queue size as explained above. If there is no congestion the packet is simply added to the router's incoming queue (or more likely processed almost immediately) and the routine returns to step S1. If, however, there is congestion the packet is not marked as would normally happen with the RED algorithm, but this indication is used instead to initiate the method of the present invention. The routine proceeds to step S3 where a marking probability is determined for packets in the queue. This marking probability is based upon the number of hops (i.e. routers) that each packet in the queue has traversed. In general packets having a lower number of hops will be assigned a higher marking probability, and packets having a higher number of hops will have a lower marking probability. How the marking probability is determined will be explained in greater detail below.

Once the marking probability has been determined the queue is examined at step S4 to ascertain which packets in the queue to drop. By assigning the marking probability as mentioned above, packets that are further (in the sense of network nodes) from their source are protected relative to those that are nearer. In this way, capacity of the network is saved. Once packets have been dropped from the queue, if any, the routine returns to step S1.

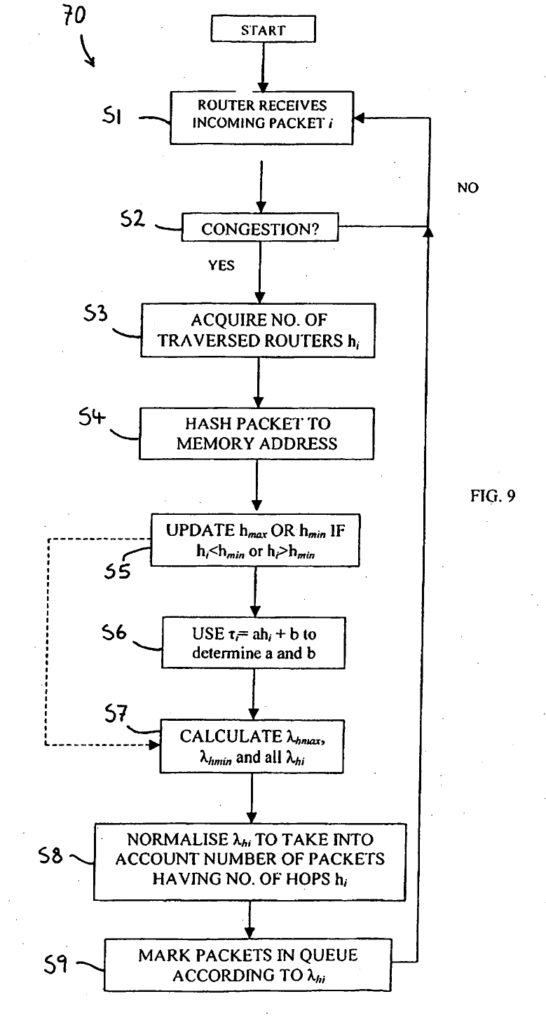

Referring to FIG. 9 a flowchart representing a first embodiment of a method is generally identified by reference numeral 70. The method of the first embodiment is referred to as the “exact” method. In this case an individual marking probability is determined for each hop number. For example, packets having traversed one router will be dropped with probability λ₁, packets having traversed two routers will be dropped with probability λ₂ etc. that is described in greater detail below.

At step S1 the router 61 receives a packet i from another router that is part of the Internet. The packet is added to the router's packet queue. At step S2 the RED algorithm determines whether or not the addition of the packet to the queue has generated a congestion condition. If not the routine returns to step S1. If there is a congestion condition the router 61 examines the packet at step S3 and ascertains the number of hops that the packet has traversed.

Not all IP headers will begin their journey with the same TTL or HL value. Different operating systems will use different default TTL and HL values. Both of these fields are 8 bits and all values used will be powers of two (with a maximum of 255). Some examples of the different TTL default values are as follows:
UNIX and UNIX-like operating systems use 255 with ICMP query replies
Microsoft Windows uses 128 for ICMP query replies
LINUX Kernel 2.2x and 2.4x use 64 with ICMP echo requests
FreeBSD 3.4, 4.0, 4.1; Sun Solaris 2.5.1, 2.6, 2.7, 2.8; OpenBSD 2.6, 2.7; NetBSD and HP UX 10.20 all use 255 with ICMP echo requests p1 Windows 95/98/98SE/ME/NT4 WRKS SP3, SP4, SP6a/NT4 Server SP4 all use 32 with ICMP echo requests
Microsoft Windows 2000 uses 128 with ICMP echo requests

Since it is thought possible to reach almost any host in less than 32 hops (http://watt.nlanr.net), it is straightforward for a router to determine the number of hops that the packet has traversed. For example, assuming that the packet has TTL or HL value of 116 at the router it is reasonable to assume that it had and initial TTL value of 128 and has therefore passed across 12 routers. Similarly if the TTL value is 54 at the router it is reasonable to assume that the initial TTL value was 64 and therefore that the packet has passed across 10 routers. The probability that this is not the case is negligible.

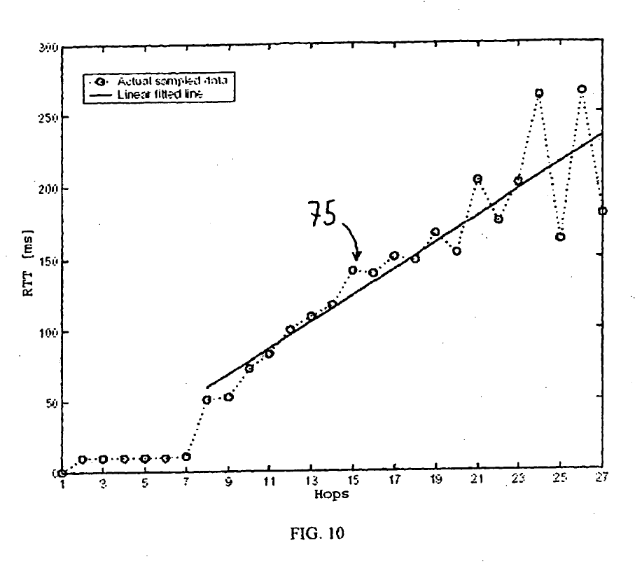

Once the number of hops of the packet i has been determined the routine proceeds to step S4 where the packet is hashed to a memory address for easy recall by the router. At step S5 the packets in the queue held by the router are examined to determine the packet having the maximum number of hops hₘₐₓ and the packet having the least number of hops hₘᵢₙ. At step S6 coefficients a and b are determined from the equation:
τᵢ=ahᵢ+b
where τᵢ is the round trip time and hᵢ is the number of hops. This equation is representative of the linear relationship between round trip time and propagation delay. Referring to FIG. 10 a sample of data illustrating hᵢ against τᵢ is generally identified by reference numeral 75. As shown the trend is linear and a line may be fitted using a least squares approximation. From this it is possible to determine the coefficients a and b. The data shown in FIG. 10 can be obtained by sampling packets at a router using a method described by H. Jiang, C. Dovrolis, “Passive Estimation of TCP Round Trip Time”, ACM SIGCOMM, Computer Review, Volume 32, Number 3 July 2002. Such sampling can be done every iteration of the method, or may be done only periodically. Alternatively any appropriate traffic model may used that can either be static or dynamic to determine a and b.

The actual relationship between number of hops and RTT will almost certainly vary from router to router, and therefore so will a and b. Typically, however, flows with a large number of hops have a higher variation in RTT due to additive process of jitter in each router i.e. the random delay caused by queuing. Nevertheless, each router's “view” of the Internet in terms of packet RTT will be different, and will depend for example on a number of different parameters such as geographical location of the backbone (tier 1 routers), the interconnection with other backbones and sub-networks. For example, traffic exchanged between national backbones can have high RTT but a low number of hops since the physical distance between hops is large. A packet travelling from Los Angeles to New York would take 40 ms to traverse the 2500 miles given a propagation speed of two-thirds the speed of light and no intermediate routers. A tier 1 gateway router exchanging transatlantic traffic will have RTT distribution very different to a tier 2 or 3 gateway router serving an small autonomous system in France for example. Furthermore, the relationship between RTT and number of hops is likely to vary over time.

One solution for determining the frequency of sampling the distribution of RTT in a given router is to use capacity of the outbound link, the maximum number of packets that the router can hold and the average packet size. In particular the refreshing time ω in seconds is given by:

$$ω = n \frac{8 pq}{C}$$

where p is the average packet size in bytes, q is the maximum number of packets that the router can buffer, C is the capacity of the outbound link in bits/s, and n is an integer that may be chosen by the network administrator or adjusted automatically by the router. n may be chosen so that a and b are refreshed every 30 s or so. Of course, this can be done more or less frequently. However, there is a balance to be struck between accuracy and processing resources of the router's CPU. Refreshing every 30 s is expected to be appropriate for most routers.

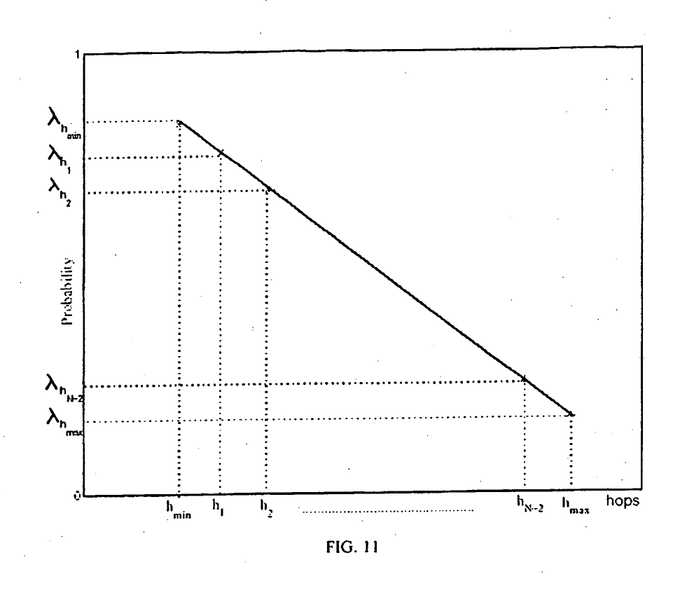

At step S7 the marking probability for packets having the maximum number of hops (λₕ_{ₘₐₓ}), the marking probability for packets having the minimum number of hops (λₕ_{ₘᵢₙ}) and the marking probability for packets having i number of hops (λₕ_{ᵢ}), are calculated as follows:

$${λ}_{{h}_{min}}^{- 1} = 1 + ( N - 1 ) {( \frac{{ah}_{min} + b}{{ah}_{max} + b} )}^{2} + ( N - 2 ) \frac{{h}_{max}}{{h}_{max} - {h}_{min}} ( 1 - {( \frac{{ah}_{min} + b}{{ah}_{max} + b} )}^{2} ) - \frac{1}{{h}_{max} - {h}_{min}} ( 1 - {( \frac{{ah}_{min} + b}{{ah}_{max} + b} )}^{2} ) {\sum }_{i = 1}^{N - 2} {h}_{i} {λ}_{{h}_{max}} = {{λ}_{{h}_{min}} ( \frac{{ah}_{min} + b}{{ah}_{max} + b} )}^{2}$$

$$and$$

$${λ}_{{h}_{i}} = - \frac{{λ}_{{h}_{min}} - {λ}_{{h}_{max}}}{{h}_{max} - {h}_{min}} {h}_{i} + {λ}_{{h}_{max}} + {h}_{max} \frac{{λ}_{{h}_{min}} - {λ}_{{h}_{max}}}{{h}_{max} - {h}_{min}}$$

where N is number is the number of different hop numbers in the queue i.e. hₘₐₓ−hₘᵢₙ. The relationship between the number of hops hᵢ and marking probability λₕ_{ᵢ} is shown graphically in FIG. 11. The relationship is linear with hᵢ being inversely proportional to λₕ_{ᵢ}, although linearity not essential. However, a linear relationship renders calculation easier and the above equations are based on this linear relationship. The slope of the line in FIG. 11 is such that the ratio of the transmission rate between the flow with the maximum number of hops and the flow with the minimum number of hops is approximately one (of course, it would be possible to assign any value if flows are to be treated differently). The average transmission rate of a host is known to be expressed as

$$r = \frac{p \sqrt{\frac{3}{2}}}{τ \sqrt{δ}}$$

where p is the maximum packet size, τ is the RTT and δ is number of packets lost per unit time. Accordingly,

$$\frac{{r}_{{h}_{min}}}{{r}_{{h}_{max}}} \approx 1 -> \frac{{τ}_{{h}_{max}}}{{τ}_{{h}_{min}}} \sqrt{\frac{{δ}_{max}}{{δ}_{min}}} = 1$$

Since the packet loss for flow with maximum transmission rate and the flow with minimum transmission rate will be each be proportional to λₕ_{ₘₐₓ} and λₕ_{ₘᵢₙ} respectively we can write

$$\frac{{τ}_{{h}_{max}}}{{τ}_{{h}_{min}}} \sqrt{\frac{{λ}_{{h}_{max}}}{{λ}_{{h}_{min}}}} = 1$$

and recalling that τᵢ=ahᵢ+b, we can also write

$$\frac{{λ}_{{h}_{max}}}{{λ}_{{h}_{min}}} = {( \frac{{ah}_{min} + b}{{ah}_{max} + b} )}^{2} .$$

This enables λₕ_{ₘₐₓ}, λₕ_{ₘᵢₙ} and λₕ_{ᵢ} to be easily determined on the basis of the number of hops of packets in the queue as shown above. It will be appreciated that

$${λ}_{{h}_{max}} + {λ}_{{h}_{min}} + {\sum }_{i = 1}^{N - 2} {λ}_{ {h}_{i}} = 1$$

in this case.

Having determined λₕ_{ₘₐₓ}, λₕ_{ₘᵢₙ} and λₕ_{ᵢ} they are normalised at step S8 to ensure that they are not biased. If there are nₕ_{ₘᵢₙ}, n₁, . . . nᵢ . . . n_{N-2}, nₕ_{ₘₐₓ} packets per hop and if the percentage of packets per hop is given by νₕ_{ₘᵢₙ}, ν₁, . . . νᵢ . . . ν_{N-2}, νₕ_{ₘₐₓ}, where νᵢ=nᵢ/n and n=nₕ_{ₘᵢₙ}+n₁+ . . . +nᵢ+ . . . +n_{N-2}+nₕ_{ₘₐₓ}, then the normalised marking probabilities for each hop are:

$${π}_{{h}_{min}} = {λ}_{{h}_{min}} \cdot \frac{{𝓋}_{{h}_{min}}}{π} , {π}_{1} = {λ}_{1} \frac{{𝓋}_{1}}{π} , … , {π}_{{h}_{max}} = {λ}_{{h}_{max}} \cdot \frac{{𝓋}_{{h}_{max}}}{π}$$

where π=λₕ_{ₘᵢₙ}νₕ_{ₘᵢₙ}+λ₁ν₁+ . . . +λ_{N-2}ν_{N-2}+λₕ_{ₘₐₓ}νₕ_{ₘₐₓ}.

At step S9 the router uses the normalised marking probabilities to drop packets from the queue. The queue is examined and for each group of packets having a particular hop number hₘᵢₙ, . . . hᵢ . . . , hₘₐₓ packets are dropped at random from each group according to the probability for that group. Marking packets may consist of dropping a packet, setting the ECN bit in the IP header or performing any other operation recognised by the transport protocol. Having done this, the routine returns to step S1 and awaits receipt of another congestion signal to initialise the method. Packets marked in this way cause the recipient to reduce their cwnd and thereby cause the sender to reduce their transmission rate. If a packet is marked by dropping it, the receiver will reduce their cwnd by half (if using TCP Reno). If the ECN bit is set, the receiver will still receive the packet (assuming it is not lost at subsequent routers) and the transport protocol can react accordingly e.g. by reducing cwnd by half. However, setting the ECN bit has the advantage that the packet is does not have to be re-sent, but a congestion condition can be signalled to the receiver. Further details of the ECN field can be found in RFC3168. In particular, the quality of service of TCP users with relatively high RTT is maintained or enhanced since their packets are marked with a lower probability at this point in their journey than TCP users with comparatively lower RTT. However, the TCP users with the lower RTT will be able to recover their transmission rate more quickly.

As indicated by the dashed arrow in FIG. 9 it is possible that step S6 may be by-passed. In particular, and as explained above, the values of a and b may be re-calculated at regular intervals rather than every iteration of the method. This reduces the demand on the router's processing resources.

The “exact” method described above is particularly useful for devices at the “edge” of the Internet, such as wireless devices, where hosts connect to and disconnect from the Internet frequently. The traffic pattern of such devices will be different to that of desktop users and will frequently be of shorter duration. Furthermore, packets for these devices will normally have crossed a much larger number of routers. It is important to protect this traffic near the edge of the Internet to prevent wasting capacity in the network by re-transmission of higher RTT packets. The method assigns a greater probability of marking those packets that are nearer to the router in the sense of hops. There is also a good chance that these packets will have been sent from a cache in a nearby router so that to re-send them will be less onerous on network resources than those that have crossed more routers. The result is that the average throughput of all users is increased and the number of packets crossing the backbone of the Internet is reduced. The method does not rely upon flow information and is implemented only when the router detects congestion. It is therefore efficient in terms of the router's CPU resources.

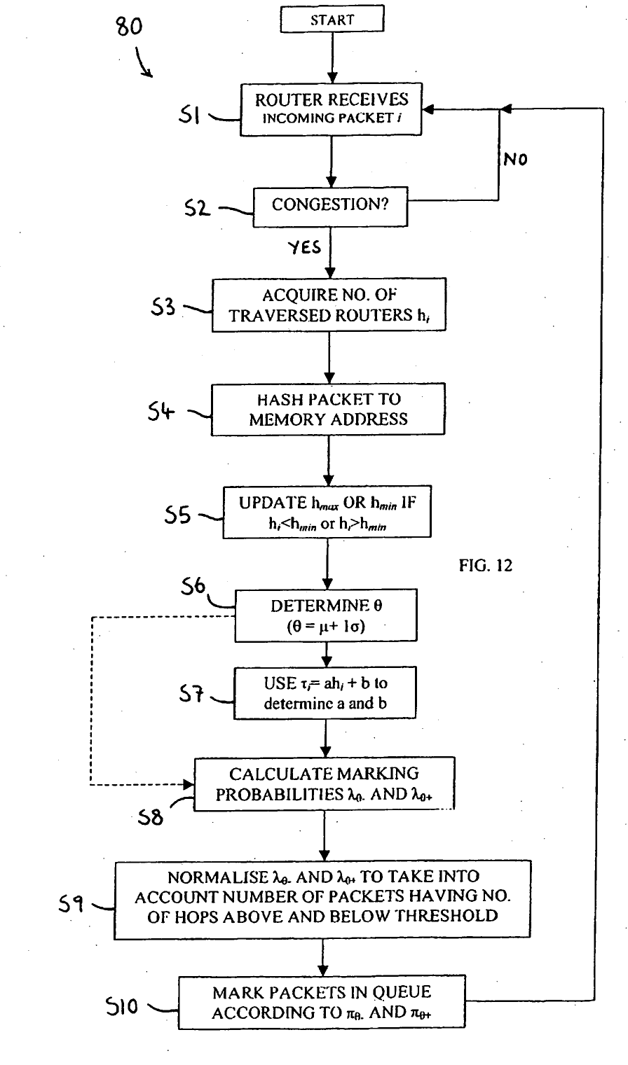

Referring to FIG. 12 a second embodiment of a method is generally identified by reference numeral 80. This method is referred to as the “coarse” method. In this case a threshold θ is set for the number of hops, above and below which is a respective constant marking probability. This method is considerably simpler to implement than the exact method.

Steps S1 to S5 are identical to those described above in connection with FIG. 9. At step S6 the threshold θ is determined as follows:
θ=μ+1σ
from the distribution of number of hops in the router's queue where θ=μ+1σ is one standard deviation. θ is set in this manner to protect flows with a high number of hops at the router. It will be readily appreciated that:
λ_{θ}_{_{−}}+λ_{θ}_{₊}=1

where λθ_{_{−}} is the marking probability for packets having traversed fewer hops than the threshold θ, and λ_{θ}_{₃₀} is the marking probability for packets having traversed more hops than the threshold θ.

At step S7 the values a and b are updated in the same way as they are determined in the exact method described above. In this case, however, only two marking probabilities need to be calculated at step S8 as follows:

$${λ}_{{θ}_{-}} = {[ 1 + {( \frac{{ah}_{min} + b}{{ah}_{max} + b} )}^{2} ]}^{- 1}$$

$${λ}_{{θ}_{+}} = 1 - {λ}_{{θ}_{-}}$$

The two marking probabilities need to be normalised to π_{θ}_{_{−}} and π_{θ}_{₊}. This is done at step S9 as follows:

$${π}_{{θ}_{-}} = {[ 1 + {( \frac{{ah}_{min} + b}{{ah}_{max} + b} )}^{2} ]}^{- 1} \frac{{𝓋}_{{θ}_{-}}}{{λ}_{{h}_{min}} {𝓋}_{{θ}_{-}} + {λ}_{{h}_{max}} {𝓋}_{{θ}_{+}}}$$

$${π}_{{θ}_{+}} = {{( \frac{{ah}_{min} + b}{{ah}_{max} + b} )}^{2} [ 1 + {( \frac{{ah}_{min} + b}{{ah}_{max} + b} )}^{2} ]}^{- 1} \frac{{𝓋}_{{θ}_{+}}}{{λ}_{{h}_{min}} {𝓋}_{{θ}_{-}} + {λ}_{{h}_{max}} {𝓋}_{{θ}_{+}}}$$

At step S10 the router marks packets in the queue according to π_{θ}_{_{−}} and π_{θ}_{₊}. As explained above, marking may be by dropping a packet, setting the ECN bit in an IP header or any other mechanism understood by the transport protocol. Packets marked in this way cause the recipient to reduce their cwnd. If a packet is marked by dropping, the receiver will reduce its cwnd by half if using TCP. If the ECN bit is set, the receiver will still receive the packet (assuming it is not lost at subsequent routers) and the transport protocol can react accordingly e.g. by reducing cwnd by half. However, this has the advantage that the packet is does not have to be re-sent, but a congestion condition can be signalled to the receiver. Further details of the ECN field can be found in RFC3168. Furthermore step S7, determining a and b, can be omitted as in the exact method described above, and these values can be refreshed periodically.

It is expected that the coarse method will more likely be applied in routers where CPU resources are scarce e.g. routers on the Internet, and particularly but not exclusively gateway routers i.e. those routers between autonomous systems. It is also possible that the “constant” values will vary as a and b change i.e. as the RTT relationship against number of hops changes in the router. a and b might also be varied in accordance with a traffic model is desired.

This second method helps to protect packets that have traversed a number of hops greater than θ relative to those having a number of hops less than θ. In this way packets at the router that have been resident on the Internet longer and have travelled further (in the sense of hops) are favoured in a congestion scenario. Where packets have to be marked, causing re-transmission, it is of packets nearer in the sense of hops so that less capacity is used in re-transmission and less packets must cross the backbone. This has the effect of higher average performance for users, particularly those with relatively large RTT.

It will be apparent that more than one threshold θ can be set, if deemed appropriate to provide finer resolution or if the RTT tends to be clustered around several hop values. For example constant probabilities may be set in bands, e.g. 1 to 5 hops, 6 to 15 hops and 16 to 35 hops. Each band will have a different marking probability, but the probability is substantially constant over each band. As more and more thresholds are added the assignment of probability will reduce to the exact method described above.

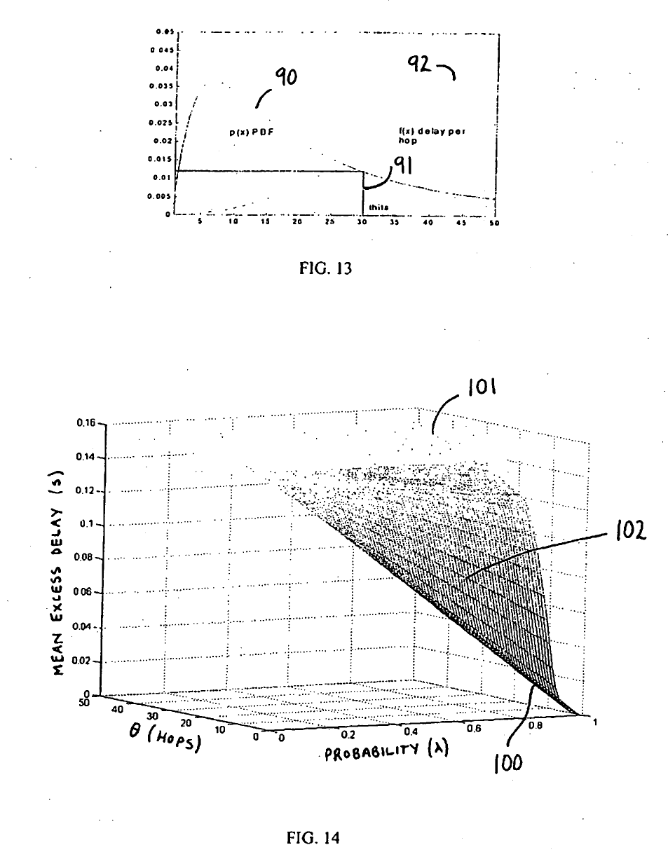

Referring to FIG. 13 a typical probability density function (pdf) of the number of hops in the queue of a router is generally identified by reference numeral 90. The left hand y-axis shows relative frequency. The pdf 90 takes the form of a lognormal distribution with a low mean number of hops. However, the “tail” of the pdf represents those packets that have been on the Internet longer and have travelled across a higher number of routers, and it is these flows that the methods of the invention intend to protect. The threshold θ is shown at 91 and is set at the mean number of hops plus one standard deviation. A dashed line 92 represents the overall delay faced by packets (right-hand y-axis). This shows the dramatic increase in average delay as the number of hops -increases. Therefore, by protecting packets with higher hop counts to reduce the need for re-transmission over the Internet, a disproportionate amount of network capacity can be saved, increasing the average quality of service for all users. Where packets are dropped in accordance with the method, the lower number of hops of these packets means that the sender's congestion window will return to its previous value more quickly.

Referring to FIG. 14 a theoretical surface representing performance of the second (coarse) method above is generally identified by reference numeral 100, and a theoretical surface representing a drop-tail method is generally identified by reference numeral 101. As is seen the surface 100 deteriorates to a drop-tail method if the marking probability is reduced to zero for any value of the threshold θ, also increasing the mean excess delay to a maximum. Theoretically, the best performance is obtained when θ is near zero and the marking probability is near 1 i.e. all packets of a low hop count are dropped. Clearly this is not practical, as this would introduce a strong bias against these flows and requires the buffer of the router top have infinite size. A useful working area where a balance can be achieved is shown by reference numeral 102.

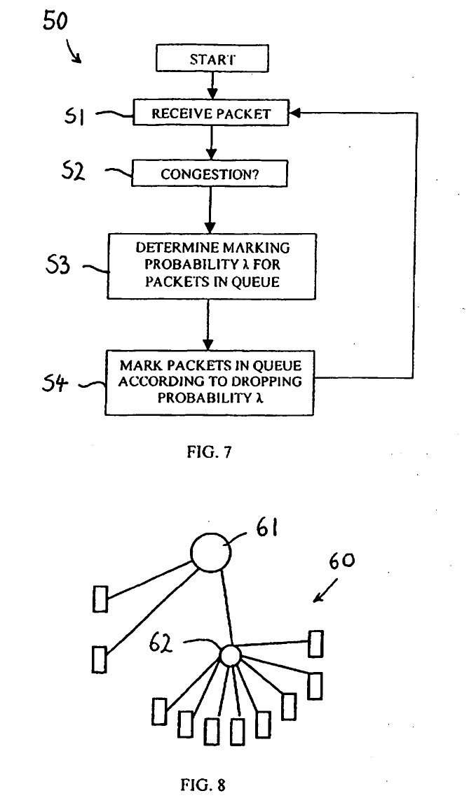

Referring to FIG. 8 a schematic view of the network used to test the present invention is generally illustrated by reference numeral 60. The network 60 comprises a gateway 61 through which packets of data for ten users pass from different remote hosts over the Internet (not shown). Data for eight of the users is cached by a close server 62 with a 5 ms one-way trip time between sender and receiver. Two users receive data directly from the gateway 61, there being a 90 ms one-way delay between the remote hosts and the two users.

The simulation was performed using a drop-tail method to indicate congestion i.e. when the gateway's incoming packet buffer is full, further incoming packets are dropped. In this condition, the second (coarse) method described above was employed to drop packets from the queue to help relieve the congestion whilst maintaining or enhancing performance of the users with large RTT. In all simulations π_{θ}_{_{−}} was 0.8 and π_{θ}_{₊} was 0.2. In order to simulate congestion at the gateway 61, a bulk data transfer model was used to ensure that data was continuously sent to bring out the full effects of packet loss on transmission rate under TCP, and users and servers implement a default congestion avoidance algorithm that is TCP Tahoe.

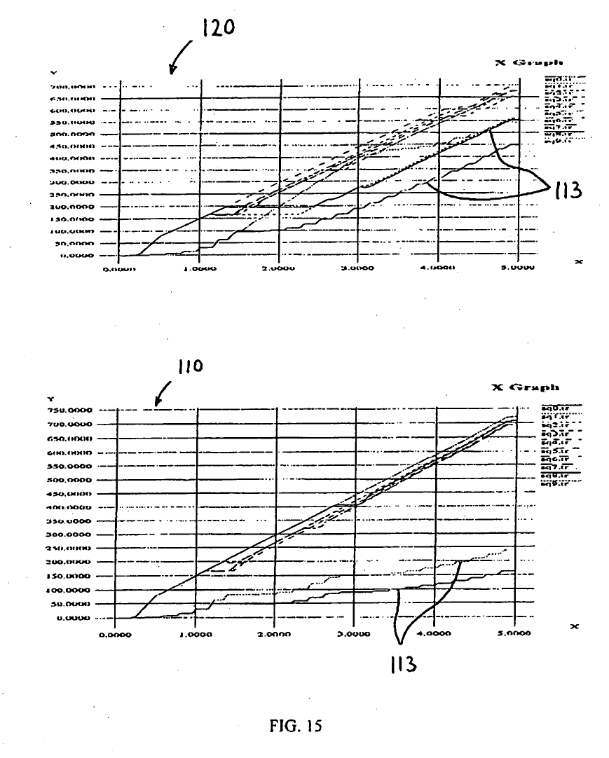

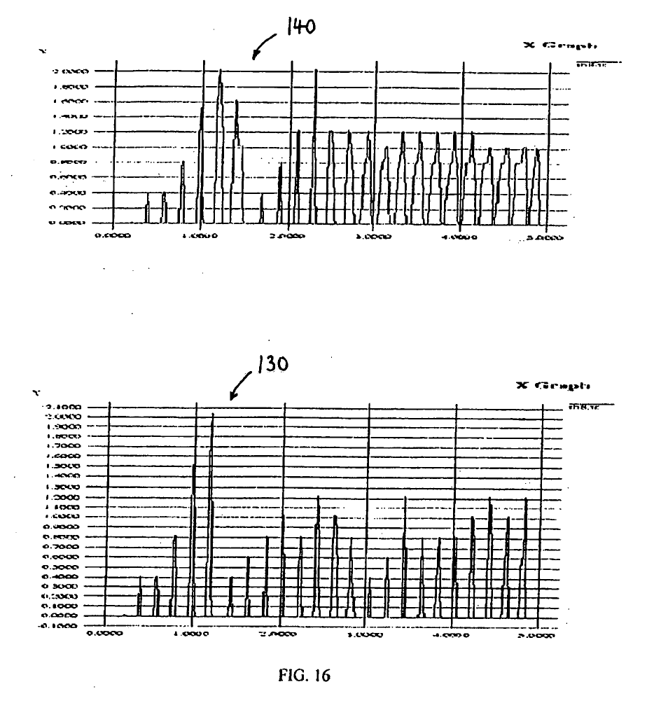

Referring to FIG. 15 a lower graph 110 shows sequence number (y-axis) against time (x-axis) for the ten users when the gateway 61 employs solely a drop-tail method. Traces 113 for the two users served directly by the gateway show their poor quality of service compared to the other eight users. At the end of the simulation the mean final sequence number of the two users is only 28.5% of the mean final sequence number of the other eight users i.e. the two users only received 28.5% of the data received by the other eight users.

An upper graph 120 in FIG. 15 shows sequence number (y-axis) against time (x-axis) for the ten users when the gateway 61 employs the coarse method described above. It is clearly seen that the performance of the two users served directly by the gateway 61 is dramatically improved. The mean sequence number of these two users at the end of the simulation was 40% higher than at the end of the drop-tail method. Of course, there is a trade off in terms of performance of the remaining eight users. However, their mean sequence number at the end of the simulation was reduced by only 8.85%. The ratio between the maximum sequence number of all users and minimum sequence number of all users in these simulations was 4.35 for drop-tail and 1.54 for the coarse method of the invention. By protecting flows with high RTTs the variance of the drop-tail method is reduced. At present with the mean size of Web pages at around 4.4 kb, the transport protocol will most likely operate within the slow-start phase of TCP to send the entire page. For mobile users with wireless devices at the edge of the Internet, downloads are likely to be even smaller. Accordingly, the dominant parameter that affects the throughput of the router will be RTT. The methods of the present invention help TCP connections and other transport protocols with a large RTT to maintain sufficient throughput.

Referring to FIG. 16 a lower graph generally identified by reference numeral 130 shows throughput in kBs⁻¹ (y-axis) against time (x-axis) for one of the two users connected directly to the gateway 61. The throughput oscillates with time after the start up phase (0-2 s) and has high peak values (1.2 kBs⁻¹) and low minimum values (0.4 kBs⁻¹). An upper graph generally identified by reference numeral 140 shows the same parameters for the same user, but the gateway 61 employs the coarse method described above. The throughput for this user is smoother and does not oscillate as much after the start up phase (0-2 s) with a peak value of 1.2 kBs⁻¹ and minimum value of 1.0 kBs⁻¹. Accordingly, the average throughput is higher when employing the methods of the invention.

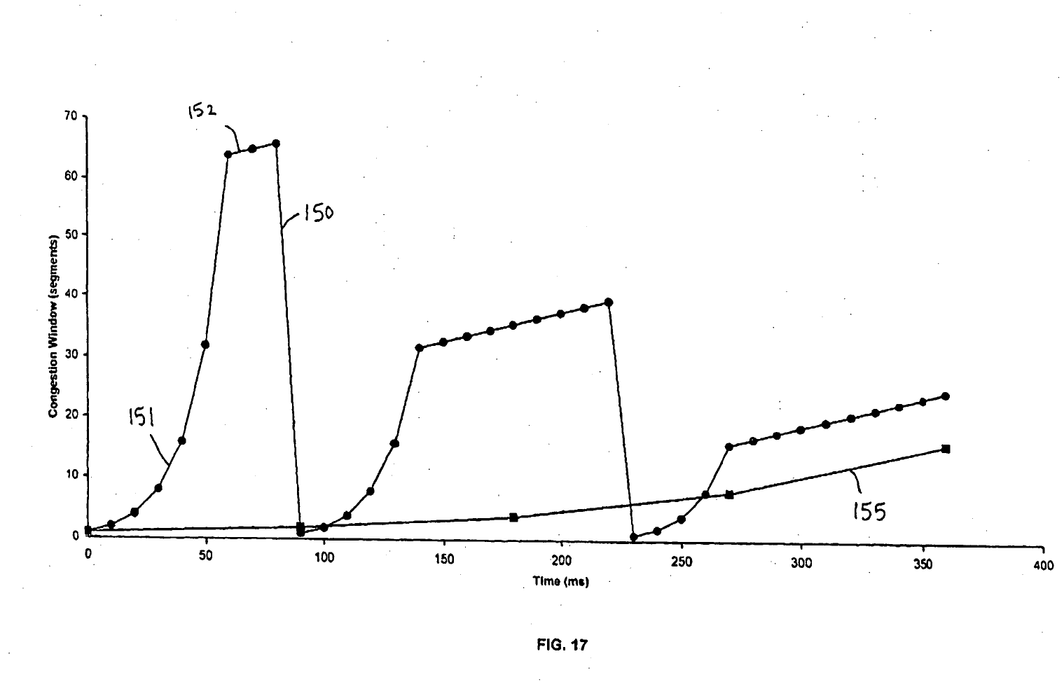

Referring to FIG. 17 a graph of time against congestion window in segments serves to illustrate the variation in transmission rates of users with different RTTs. A first user's transmission rate under TCP Tahoe is illustrated by trace 150. This user is communicating with another user with a round-trip time of 10 ms. As is seen the transmission rate increases exponentially in the slow-start phase 151, until the slow-start threshold is reached at which point the transmission rate increases linearly in the congestion avoidance phase 152. At point 153 the sender receives a triple duplicate acknowledgement from the receiver indicating that a segment (in a packet) is missing somewhere in the network. Accordingly, inferring that there is congestion on the network, the sender drops transmission rate back to one segment and enters the slow-start phase again.

A second user's transmission rate under TCP Tahoe is illustrated by trace 155. This user is experiencing a TCP session with another user in which packets have a RTT of 90 ms. Although the second user's transmission rate is also increasing exponentially in the slow-start phase, exponential increases can only be made every round trip interval when an acknowledgement of a safely received packet arrives back at the sender. Accordingly, relative to the first user, the second users average increase in transmission rate is much lower. Furthermore, in the event that a segment of the second user is lost or dropped, it will take the user much longer to recover to their previous transmission rate. Some mechanisms can help the second user to achieve a fast recovery, e.g. TCP Reno where transmission rate is cut in half after receipt of a triple duplicate acknowledgement rather than being reduced back to one. Nevertheless, it will still take the second user longer to recover their transmission rate than the first user.

There is a high probability that the second user is transmitting packets over a much larger number of routers than the first user. Thus it is apparent that, in the event of congestion at a router, it would be preferable to mark packets from the first user with a higher probability than packets from the second user, as described above. In this way, performance in terms of data transmission rates is maintained or enhanced for the second user during a congestion condition. As explained above with reference to FIG. 15, a disproportionate increase in the second user's performance can be obtained with only a small sacrifice in performance of the first user.

It is of course possible that the marking probabilities can be determined by some parameter, other than the number of network nodes crossed by a packet. For example, the marking probability may be determined by the round trip time or one-way trip time. In essence, the marking probability is obtainable by any parameter representative of the amount of time a packet has spent resident on the network.

Although primarily described with reference to TCP/IP the present invention is not limited to the protocols and may use others, for example UDP, although in this case the user's transmission rate is not controllable by marking a packet. The end hosts may use any version of TCP. Furthermore the transport protocol (that recognises a marked packet) may be at a higher layer than the transport layer.

With the transition between IPv4 and IPv6 there will be an appreciable time where the network consists of predominantly IPv4 networks interspersed with IPv6 network “islands”. If we consider a packet travelling from one IPv6 island to another it will be apparent that the IPv6 packet must be tunnelled over an IPv4 network. At a first gateway between the networks the IPv6 packet is simply encapsulated in an IPv4 header i.e. the IPv6 header is not removed. Accordingly the packet will be reset in terms of hop number. That is the IPv4 TTL field will commence from its highest value at the first gateway. The packet is then sent across the IPv4 network. At a second gateway between the networks the IPv4 header is stripped off the original IPv6 header plus data and the packet is sent onto the IPv6 network toward its ultimate destination. The methods of the present invention can readily be applied in these circumstances. For example, it would be advantageous to operate the method at the first and second gateway routers as these routers have a complete view of the network over which the respective packets have travelled. At the first gateway packets moving onto the IPv4 network will have reached their maximum hop count on the first IPv6 network and therefore it is advantageous to apply the methods of the invention at this point. Similarly, IPv6 packets encapsulated in an IPv4 header at the second gateway will have their maximum hop count on the IPv4 network.

The present invention is applicable in the Differentiated Services (Diffserv) architecture that is presently the subject of much research (see for example www.ietf org/html.charters/diffserv-charter.html and RFC2475). It may be applied in routers at the “edge” of the network where traffic classification and conditioning is performed by Diffserv capable routers, or at the core of the network where per-hop behaviour (PHB) is used to forward packets in a manner that results in an externally observable performance difference between different flow classes.

One of the proposed PHB mechanisms is “assured forwarding” (AF). AF divides traffic into four classes, where each AF class is guaranteed to be provided with some minimum amount of bandwidth and buffering. Within each class packets are further partitioned into one of three “drop preference” categories. When congestion occurs within an AF class, a router can drop packets based on their drop preference values. These drop preference values can be determined on a “leaky bucket” basis (see RFC2597). The router maintains two sets of RED thresholds for each AF class. One threshold corresponds to an “in profile” transmission rate of a host i.e. the transmission rate does not exceed the host's agreed maximum, and the other threshold corresponds to an “out of profile” transmission rate for a host i.e. the transmission rate exceeds the host's agrees maximum. Thus the router maintains four virtual queues based on class, each of which is further divided into two virtual queues based on in profile and out of profile transmission rates. On an indication of congestion for any of the virtual queues the present invention can be applied to mark less sensitive packets in flows less sensitive to packet loss with a higher probability than those flows that are more sensitive. Additionally or alternatively the present invention may determine the three (or more) drop preference categories in each AF class to help maintain or enhance performance for users in each AF class. It will be apparent that the marking probabilities of the present invention can be set in this circumstance to maintain the different agreed performance level experienced by users in each class.

A further area where the present invention is expected to be particularly advantageous is in ad-hoc networking. Such a network comprises a number of mobile devices (usually wireless) that has no central control and no connections to the outside world i.e. it is autonomous. There are typically a maximum of approximately 200 devices in an ad-hoc network. The network is formed simply because there happens to be a number of devices in the proximity of one another that need to communicate. However, they do not find an existing network infrastructure such as an IEEE 802.11 with a base station set and access point. An ad-hoc network might be formed for example when people meet with notebook computers in a conference room, train or car and want to exchange data. One or more (preferably all) of the devices will take on a routing or switching function and may be provided with a method in accordance with the present invention. It is expected that the “coarse” method as described above will be particularly useful here as network resources will be limited and, as users will join and leave the network continuously, it is important that flows traversing the highest number of “routers” are protected relative to those with a relatively low number of hops. One particular advantage of the method applied to ad-hoc networks is that the overall energy consumed by all of the routing devices to receive, process and transmit each packet is reduced. Reducing energy consumption is important in devices that run from battery, such as laptops, PDAs, mobile telephones, etc.

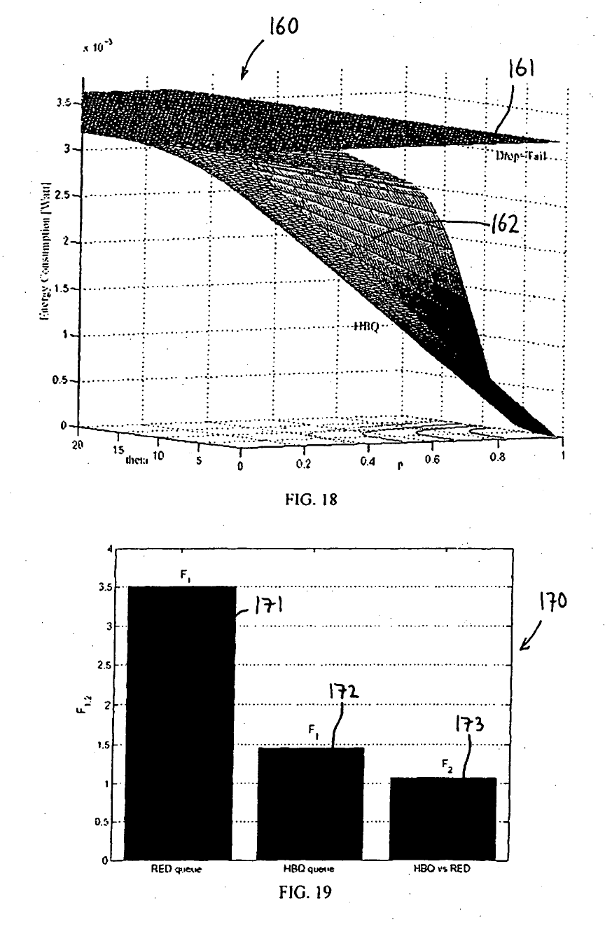

Referring to FIG. 18 a three dimensional graph of marking probability against threshold θ and energy consumption is generally identified by reference numeral 160 for a wireless ad-hoc network. A simulation was performed of an ad-hoc network with ten mobile nodes spaced equi-distantly in one-dimensional line where during the period of the measurements each node transmits traffic to all the other nodes. An energy consumption model as described in W. R. Heinzelman et al., “Energy efficient communication protocol for wireless microsensor networks”, Proc. Hawaii International Conference on System Sciences, pages 4-7, January 2000 was assumed. For routing purposes energy consumption is considered in terms of the electrical energy consumed (from a battery) to receive, process and transmit each packet of data. Data was sent between each and every network node over a period of 30s. The traffic model was such that the buffers in the routers of the ad-hoc network are quickly saturated so that some form of queue management is needed to maintain the quality of service for all nodes.

Network nodes of the simulated ad-hoc network that perform routing firstly used the drop-tail method and then secondly the coarse method (as described above) to drop packets when a congestion condition is detected. The energy consumption of the ad-hoc network was monitored. As shown in FIG. 18 the drop-tail method of queuing packets at the routing network nodes (i.e. those that are performing a routing function in the ad-hoc network) generates constant mean energy consumption 161 over the network. In comparison, the coarse method of dropping packets based on the number of hops they have traversed offers advantages in terms of mean energy consumption 162 over the network. As seen the coarse method always generates less energy consumption. This believed to be due to the fact that flows with high round-trip time (or number of “hops”) are protected relative to those with a short round-trip time. Thus, when packets do have to be re-transmitted they are more likely to be over routes with fewer hops between sender and receiver, and therefore less energy is consumed over the network as a whole.

As a further comparison, two ratios were defined as follows: F₁ is the ratio of the average TCP sequence number for flows with hop number greater than θ to the average TCP sequence number for flows with hop number less than θ; and F₂ is the ratio of the average TCP sequence number for flows with hop number greater than θ for the coarse method of queuing to the average TCP sequence number for flows with hop number greater than θ for the RED (Random Early Detection) method of queuing. TCP-based file transfers of greater 30 s were simulated over the ad-hoc network. As shown in FIG. 19 a bar graph generally identified by reference numeral 170 comprises three bars. The bar 171 represents the ratio F₁ for a RED queuing method in the ad-hoc network and bar 172 represents the ratio F₁ for a coarse method of queuing. The bar 171 of the RED method shows that the average TCP sequence number between flows with hops above and below θ is different and therefore these flows are not fairly handled. The bar 172 representing the coarse method shows that flows either side of the threshold θ are treated more fairly, as the variation in TCP sequence number has been reduced. The ratio F₂ shown by bar 173 shows that flows with a number of wireless hops greater than θ achieve a higher throughput using the coarse method of HBQ compared with the RED queue. Although F₂ is relatively near to unity, the advantages offered by the coarse (and exact) method of the invention are expected to be amplified in larger networks (the simulated network only had ten nodes).

Although the embodiments of the invention described with reference to the drawings comprise computer apparatus and methods performed in computer apparatus, the invention also extends to computer programs, particularly computer programs on or in a carrier, adapted for putting the invention into practice. The program may be in the form of source code, object code, a code intermediate source and object code such as in partially compiled form, or in any other form suitable for use in the implementation of the methods according to the invention. The carrier may be any entity or device capable of carrying the program.

For example, the carrier may comprise a storage medium, such as a ROM, for example a CD ROM or a semiconductor ROM, or a magnetic recording medium, for example a floppy disc or hard disk. Further, the carrier may be a transmissible carrier such as an electrical or optical signal that may be conveyed via electrical or optical cable or by radio or other means.

When the program is embodied in a signal that may be conveyed directly by a cable or other device or means, the carrier may be constituted by such cable or other device or means.

Alternatively, the carrier may be an integrated circuit in which the program is embedded, the integrated circuit being adapted for performing, or for use in the performance of, the relevant methods.

1. A method of reducing packet congestion at a network node in a packet-switched data communication network, which method comprises the steps of marking one or more packets in a queue, wherein a probability of marking a packet in the queue is higher for a first proportion of the packets than for a second proportion of the packets, one or more packets of said first proportion having spent less time on said network than one or more packets of said second proportion.

2. A method as claimed in claim 1, wherein said time spent on the network is indicated by the number of network nodes crossed by each packet, the method further comprising the step of determining said probability based on said number of network nodes.

3. A method as claimed in claim 2, wherein each packet comprises an Internet Protocol (IP) header, the method further comprising the step of obtaining the number of network nodes by reading the Time To Live (TTL) field in an IPv4 header, or from the Hop Limit field (HL) in an IPv6 header of each packet.

4. A method as claimed in claim 2, further comprising the steps of examining the queue to determine a maximum number of network nodes and a minimum number of network nodes crossed by packets therein, and determining a probability of being marked for each network node number between said maximum and said minimum.

5. A method as claimed in claim 1, wherein said probability varies as a function of the time each packet has spent crossing the network or as a function of the number of network nodes.

6. A method as claimed in claim 5, wherein said function is of substantially linear form and the probability is inversely proportional to the time each packet has spent crossing the network or the number of network nodes crossed by each packet.

7. A method as claimed in claim 1, wherein said method comprises the steps of:
(a) receiving a packet on said network node;
(b) adding said packet to said queue;
(c) determining whether or not the addition of said packet to said queue causes a congestion condition in said network node;
(d) if there is a congestion condition, determining a hop number h of said packet corresponding to the number of network nodes crossed by said packet prior to reaching said network node;
(e) storing said packet in memory;
(f) examining each packet in said queue to determine the maximum hop number, hₘₐₓ, and the minimum hop number, hₘᵢₙ, present therein;
(g) determining a minimum marking probability (λₕ_{ₘᵢₙ}) for packets having said minimum hop number, obtainable from the equation:
$${λ}_{{h}_{min}}^{- 1} = 1 + ( N - 1 ) {( \frac{{ah}_{min} + b}{{ah}_{max} + b} )}^{2} + ( N - 2 ) \frac{{h}_{max}}{{h}_{max} - {h}_{min}} ( 1 - {( \frac{{ah}_{min} + b}{{ah}_{max} + b} )}^{2} ) - \frac{1}{{h}_{max} - {h}_{min}} ( 1 - {( \frac{{ah}_{min} + b}{{ah}_{max} + b} )}^{2} ) {\sum }_{i = 1}^{N - 2} {h}_{i} ,$$
determining a maximum marking probability (λₕ_{ₘₐₓ}) for packets having said maximum hop number, obtainable from the equation:
$${λ}_{{h}_{max}} = {{λ}_{{h}_{min}} ( \frac{{ah}_{min} + b}{{ah}_{max} + b} )}^{2}$$
determining an individual marking probability (λₕ_{ᵢ}) for each packet having hop number i in said packet queue, obtainable from the equation:
$${λ}_{{h}_{i}} = - \frac{{λ}_{{h}_{min}} - {λ}_{{h}_{max}}}{{h}_{max} - {h}_{min}} {h}_{i} + {λ}_{{h}_{max}} + {h}_{max} \frac{{λ}_{{h}_{min}} - {λ}_{{h}_{max}}}{{h}_{max} - {h}_{min}}$$
where N is the number of different hop numbers in the queue (i.e. hₘₐₓ−hₘᵢₙ) and a and b are coefficients depending on the relationship between round trip time and propagation delay of packets passing through said network node, obtainable from the equation τᵢ=ahᵢ+b, where τᵢ is the round trip time for packets with hop number i;
(h) normalising λₕ_{ₘₐₓ}, λₕ_{ₘᵢₙ} and λₕ_{ᵢ} to form respective normalised marking probabilities for each hop number as follows: if there are nₕ_{ₘᵢₙ}, n₁, . . . nᵢ . . . n_{N-2}, nₕ_{ₘₐₓ} packets of each hop number in said packet queue and if the percentage of packets per hop number is given by νₕ_{ₘᵢₙ}, ν₁, . . . νᵢ . . . ν_{N-2}, νₕ_{ₘₐₓ}, where νᵢ=nᵢ/n and n=nₕ_{ₘᵢₙ}+n₁+ . . . +nᵢ+ . . . +n_{N-2}+nₕ_{ₘₐₓ}, then said normalised marking probabilities are obtainable from:
$${π}_{{h}_{min}} = {λ}_{{h}_{min}} \cdot \frac{{𝓋}_{{h}_{min}}}{π} , {π}_{1} = {λ}_{1} \frac{{𝓋}_{1}}{π} , … , {π}_{{h}_{max}} = {λ}_{{h}_{max}} \cdot \frac{{𝓋}_{{h}_{max}}}{π}$$
where π=λₕ_{ₘᵢₙ}νₕ_{ₘᵢₙ}+λ₁ν₁+ . . . +λ_{N-2}ν_{N-2}+λₕ_{ₘₐₓ}νₕ_{ₘₐₓ}; and
(i) marking packets of each hop number in said queue according to the corresponding normalised marking probability.

8. A method as claimed in claim 1, wherein packets in said first proportion have a substantially constant first probability of being marked and packets in said second proportion have a substantially constant second probability of being marked lower than said first probability.

9. A method as claimed in claim 8, wherein the packets in the queue are divided into said first and second proportions by a threshold based upon the mean number of networks nodes crossed by the packets in the queue.

10. A method as claimed in claim 9, wherein the threshold is approximately equal to the mean number of hops in the queue plus one standard deviation.

11. A method as claimed in claim 8, wherein said method comprises the steps of:
(a) receiving a packet on said network node;
(b) adding said packet to said queue;
(c) determining whether or not the addition of said packet to said queue causes a congestion condition in said network node;
(d) if there is a congestion condition, determining a hop number h of said packet corresponding to the number of network nodes crossed by said packet prior to reaching said network node;
(e) storing said packet in memory;
(f) examining each packet in said queue to determine the maximum hop number, hₘₐₓ, and the minimum hop number, hₘᵢₙ, present therein;
(g) determining a hop number threshold θ from the distribution of hop numbers in said queue, where θ is one standard deviation;
(h) determining a first marking probability λ_{θ}_{_{−}} for packets having a hop number less than said hop number threshold θ, obtainable from the equation:
$${λ}_{{θ}_{-}} = {[ 1 + {( \frac{{ah}_{min} + b}{{ah}_{max} + b} )}^{2} ]}^{- 1} ,$$
determining a second marking probability λ_{θ}_{₊} for packets having a hop number greater than said hop number threshold θ, obtainable from the equation:
λ_{θ}_{₊}=1−λ_{θ}_{_{−}},
where a and b are coefficients depending on the relationship between round trip time and propagation delay of packets passing through said network node, obtainable from the equation τᵢ=ahᵢ+b, where τᵢ is the round trip time for packets with hop number i;
(i) normalising said first and second marking probabilities to form respective first and second normalised marking probabilities, π_{θ}_{_{−}} and π_{θ}_{₊}, obtainable from:
$${π}_{{θ}_{-}} = {[ 1 + {( \frac{{ah}_{min} + b}{{ah}_{max} + b} )}^{2} ]}^{- 1} \frac{{𝓋}_{{θ}_{-}}}{{λ}_{{h}_{min}} {𝓋}_{{θ}_{-}} + {λ}_{{h}_{max}} {𝓋}_{{θ}_{+}}} and$$
$${π}_{{θ}_{+}} = {{( \frac{{ah}_{min} + b}{{ah}_{max} + b} )}^{2} [ 1 + {( \frac{{ah}_{min} + b}{{ah}_{max} + b} )}^{2} ]}^{- 1} \frac{{𝓋}_{{θ}_{+}}}{{λ}_{{h}_{min}} {𝓋}_{{θ}_{-}} + {λ}_{{h}_{max}} {𝓋}_{{θ}_{+}}} ; and$$
(j) marking packets in said queue according to said first and second marking probabilities π_{θ}_{_{−}} and π_{θ}_{₊}.

12. A method as claimed in claim 1, further comprising the step of initiating the method in response to an indication of congestion at said network node caused by a queue of packets awaiting processing at said network node.

13. A method as claimed in claim 12, wherein said indication is provided by a method employing Random Early Detection (RED).

14. A method as claimed in claim 1, wherein the step of marking a packet comprises dropping the packet, setting the Explicit Congestion Notification bit in the IP header or performing any other step that identifies congestion to a transport protocol used by the intended recipient of the packet.

15. A method as claimed in claim 12, further comprising the step of repeating the method upon receipt of a further indication of congestion at the network node.

16. A computer program product storing computer executable instructions in accordance with a method of claim 1.

17. A computer program product as claimed in claim 16, embodied on a record medium, in a computer memory, in a read-only memory, or on an electrical carrier signal.

18. A network node for use in a packet-switched data communication network, which network node comprises an interface for receiving packets from other network nodes, a routing table for determining the identity of a subsequent network node to which each packet should be sent, a memory for temporary storage of packets and a processor for forwarding each packet to the subsequent network node, wherein said memory stores computer executable instructions in accordance with a method as claimed in claim 1 for execution by said processor.

19. A network node as claimed in claim 18, embodied in an OSI layer 4 routing device, for example a router and a gateway router.

20. A network node as claimed in claim 18, embodied in a wireless communication device, for example a hand-held wireless device.

21. A packet-switched data communication network comprising a plurality of network nodes, each of which can send and receive packets of data to and from other network nodes, wherein one or more network nodes is in accordance with claim 1.

22. At a network node in a packet-switched data communication network, a method of initiating a reduction in the transmission rate of packets from a first host transmitting data over that network, which method comprises the steps of:
(1) receiving a packet directly or indirectly from said first host destined for a second host reachable directly or indirectly from said network node; and
(2) either marking or not marking said packet, a probability of marking the packet being determined on the basis of the time said packet has spent reaching said network node over at least a part of said network;
wherein marking of said packet serves to cause a subsequent reduction of said transmission rate from said first host.

23. A method of reducing the aggregate battery power consumption by network nodes in an ad-hoc computer network, which method comprises the steps of:
(1) using at least one of the network nodes to route data between communicating network nodes of the ad-hoc computer network; and
(2) at one or more routing network node using a method in accordance with claim 1 to mark packets passing therethrough, whereby packets in flows of data with a roundtrip time that is high compared to other flows of data through that routing network node have a lower probability of re-transmission across the ad-hoc network, thereby reducing the aggregate battery power consumption of routing network nodes in the ad-hoc computer network.
